(19) United States
(12) Patent Application Publication
(10) Pub. No.: US 2007/0057817 A1
(43) Pub. Date: Mar. 15, 2007

(54) Systems and methods for locating a parked vehicle

(75) Inventor: Craig W. Aman, Frisco, TX (US)

Correspondence Address: LEE & HAYES, PLLC, 421 W. RIVERSIDE AVE., SUITE 500, SPOKANE, WA, 99201, US

(73) Assignee: The Boeing Company

(21) Appl. No.: 11/224,352

(22) Filed: Sep. 12, 2005

(51) Int. Cl. G08G 1/01

(52) U.S. Cl. 340/933

(57) ABSTRACT

Methods, systems, and articles of manufacture consistent with the present invention provide for locating a parked vehicle within a parking area. The parking area has a plurality of zones. Each zone is associated with a respective one of a plurality of location identifiers. A vehicle identifier associated with the vehicle is received by a data processing system. One of the location identifiers corresponding to a location where the vehicle is parked is then captured or received by the data processing system. The one location identifier is then stored in association with the vehicle identifier. When a request to locate the parked vehicle within the area is received where the request includes at least a portion of the vehicle identifier, the one location identifier is retrieved based on at least the portion of the vehicle identifier.

### BACKGROUND OF THE INVENTION

The present invention relates to systems for locating a vehicle, and, more particularly, to methods and systems for locating a vehicle within a parking facility.

Drivers often forget where they have parked their vehicles at venues such as shopping. malls, sports arenas, theme parks, and airports. Companies who manage parking facilities may track which vehicles are in their lots, but they do not track the specific vehicle location. A customer or driver who can not find their vehicle typically must rely on either wandering to find the vehicle or having parking facility managers or security officers drive them through the parking facility until they locate their vehicle. These conventional methods of locating a parked vehicle inconvenience both the driver and the person(s) having to assist with the service. Moreover, security concerns arise when security officers are required to assist a driver in locating a parked vehicle because this service takes them away from their appointed security rounds and potentially opens the facility or area to a security breach.

Therefore, a need exists for systems and methods that overcome the problems noted above and others previously experienced for locating a parked vehicle.

### SUMMARY OF THE INVENTION

In accordance with methods consistent with the present invention, a method in a data processing system is provided for locating a vehicle parked within an area having a plurality of zones. Each zone is associated with a respective one of a plurality of location identifiers. The method comprises: receiving a vehicle identifier associated with the vehicle; receiving one of the location identifiers corresponding to a location where the vehicle is parked; storing the one location identifier in association with the vehicle identifier; receiving a request to locate the parked vehicle within the area, the request including at least a portion of the vehicle identifier; and retrieving the one location identifier in response to the request, based on at least the portion of the vehicle identifier.

In accordance with articles of manufacture consistent with the present invention, a computer-readable medium containing instructions for controlling a data processing system to perform a method for locating a vehicle parked within an area is provided. The area has a plurality of zones. Each zone is associated with a respective one of a plurality of location identifiers. The method comprises: receiving a vehicle identifier associated with the vehicle; receiving one of the location identifiers corresponding to a location where the vehicle is parked; storing the one location identifier in association with the vehicle identifier; receiving a request to locate the parked vehicle within the area, the request including at least a portion of the vehicle identifier; and retrieving the one location identifier in response to the request, based on at least the portion of the vehicle identifier.

In accordance with systems consistent with the present invention, a data processing system for locating a vehicle parked within an area is provided. The area has a plurality of zones. Each zone is associated with a respective one of a plurality of location identifiers. The data processing system comprises: a first memory device further comprising a vehicle inventory manager program that receives a vehicle identifier associated with the vehicle, receives one of the location identifiers corresponding to a location where the vehicle is parked, and stores the one location identifier in association with the vehicle identifier; and a first processor that runs the vehicle inventory program. The data processing system further comprises a second memory device further comprising a vehicle locator program that receives a request to locate the parked vehicle within the area, the request including at least a portion of the vehicle identifier, and retrieves the one location identifier in response to the request, based on at least the portion of the vehicle identifier; and a second processor that runs the vehicle locator program.

In accordance with systems consistent with the present invention, a data processing system is provided for locating a vehicle parked within an area having a plurality of zones. Each zone is associated with a respective one of a plurality of location identifiers. The data processing system comprises: means for receiving a vehicle identifier associated with the vehicle; means for receiving one of the location identifiers corresponding to a location where the vehicle is parked; means for storing the one location identifier in association with the vehicle identifier; means for receiving a request to locate the parked vehicle within the area, the request including at least a portion of the vehicle identifier; and means for retrieving the one location identifier in response to the request, based on at least the portion of the vehicle identifier.

Other systems, methods, features, and advantages of the present invention will be or will become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE DRAWINGS

The accompanying drawings, which are incorporated in and constitute a part of this specification, illustrate an implementation of the present invention and, together with the description, serve to explain the advantages and principles of the invention. In the drawings:

FIG. 1 is a block diagram of an exemplary data processing system suitable for locating a parked vehicle consistent with the present invention;

FIGS. 2A-2B depict a block diagram of a portable computer system, a local parking area computer system, a vehicle inventory storage system, and an exemplary kiosk computer system suitable for use in the data processing system in FIG. 1;

FIG. 3 depicts a block diagram of a second exemplary data processing system suitable for locating a parked vehicle consistent with the present invention;

FIG. 4 is a block diagram of a local parking area computer system for use in the data processing system in FIG. 3;

FIGS. 5A-5B depict a flow diagram illustrating a process performed by a program in the data processing system to inventory vehicles parked in an area;

FIGS. 6A-6B depict a flow diagram illustrating a process performed by a vehicle locator program in the kiosk computer system to locate one vehicle from among the inventoried vehicles parked in the area in accordance with a user request;

FIG. 7 depicts an exemplary user interface screen displayed by the vehicle locator program when multiple vehicles are identified in response to the user request;

FIG. 8 depicts another exemplary user interface screen displayed by the vehicle locator program when a vehicle matching the user request is identified; and

FIG. 9 depicts a block diagram of a third exemplary data processing system suitable for locating a parked vehicle consistent with the present invention.

### DETAILED DESCRIPTION OF THE INVENTION

Reference will now be made in detail to an implementation in accordance with methods, systems, and products consistent with the present invention as illustrated in the accompanying drawings. The same reference numbers may be used throughout the drawings and the following description to refer to the same or like parts.

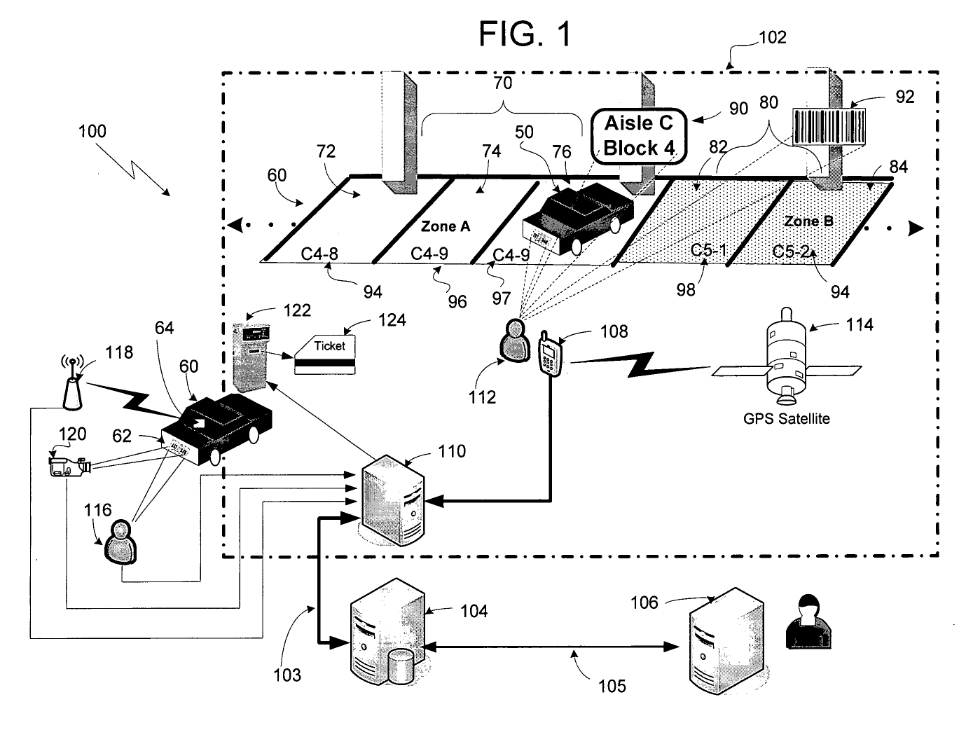

FIG. 1 depicts a block diagram of an exemplary data processing system 100 suitable for locating a vehicle (e.g., vehicle 50) parked in a lot, garage, or other parking facility (e.g., area 60) in accordance with the present invention. As shown in FIG. 1, the parking area 60 has a plurality of zones 70 and 80, which may correspond to a block or group of parking spaces within the parking area 60 or to respective parking spaces 72, 74, 76, 82, and 84 in the parking area. Each zone is assigned a corresponding location identifier or code based on the respective geographic location of the zone 70 or 80 within the parking facility 60. For example, when the zone 70 or 80 corresponds to a group of parking spaces, the location identifier may reflect a corresponding block within an aisle of the parking area 60. In the example shown in FIG. 1, zone 70 corresponds to “Aisle C Block 4” and zone 80 corresponds to zone B. When each zone 70 or 80 corresponds to a respective parking space 72, 74, 76, 82, or 84, the location identifier may reflect a corresponding number 94, 96, 97, 98, or 99 assigned to the parking space 72, 74, 76, 82, or 88.

The data processing system 100 includes a vehicle inventory gathering system 102, a vehicle inventory storage system 104 operatively connected to the vehicle inventory gathering system 102 via a first network connection 103, and a kiosk computer system 106 operatively connected to the vehicle inventory storage system 106 via a second network connection 105. The first network connection 103 and the second network connection 105 may each be any known private or public communication network connection, such as a local area network (“LAN”), a wide area network (“WAN”), or a Peer-to-Peer network using standard communications protocols. In one implementation, the first network connection 103 and the second network connection 105 may be the same network, such as the Internet.

After a vehicle 50 has been parked in the area 60, the vehicle inventory gathering system 102 is operatively configured to inventory where the vehicle 50 is parked by obtaining the license tag, a manufacturer's vehicle identification number, or other vehicle identifier associated with the vehicle (e.g., license tag 52 associated with vehicle 50), obtaining the corresponding one of the location identifiers 90, 92, 94, 96, 97, 98, or 99 reflecting the location or zone where the vehicle is parked within the area 60, and storing the one location identifier in association with the vehicle identifier. Vehicle inventory information, including the vehicle identifier and the associated location identifier, may be stored locally within the vehicle gathering system 102 or transferred for remote storage in the vehicle inventory storage system 104. As discussed in detail below, the kiosk computer system 106 is operatively configured to locate a vehicle 50 parked within the area 60 upon request from a user, such as the last driver of the vehicle 50 or a police officer looking for the owner of the vehicle 50, based on at least a portion of the vehicle identifier provided by the user matching.

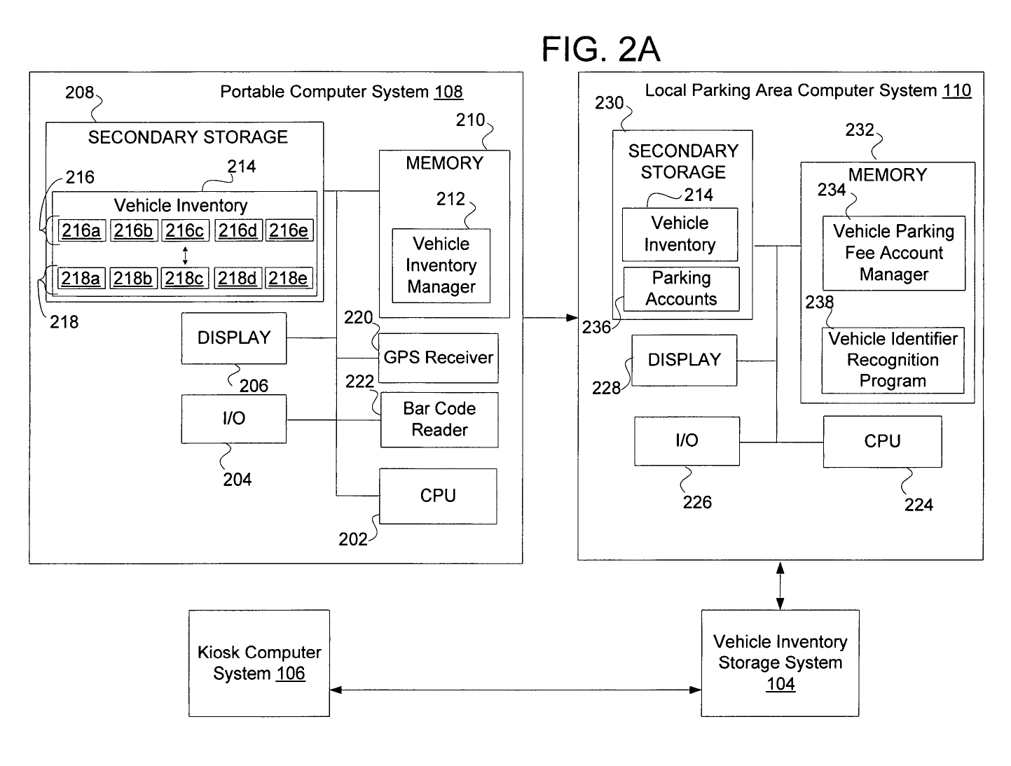

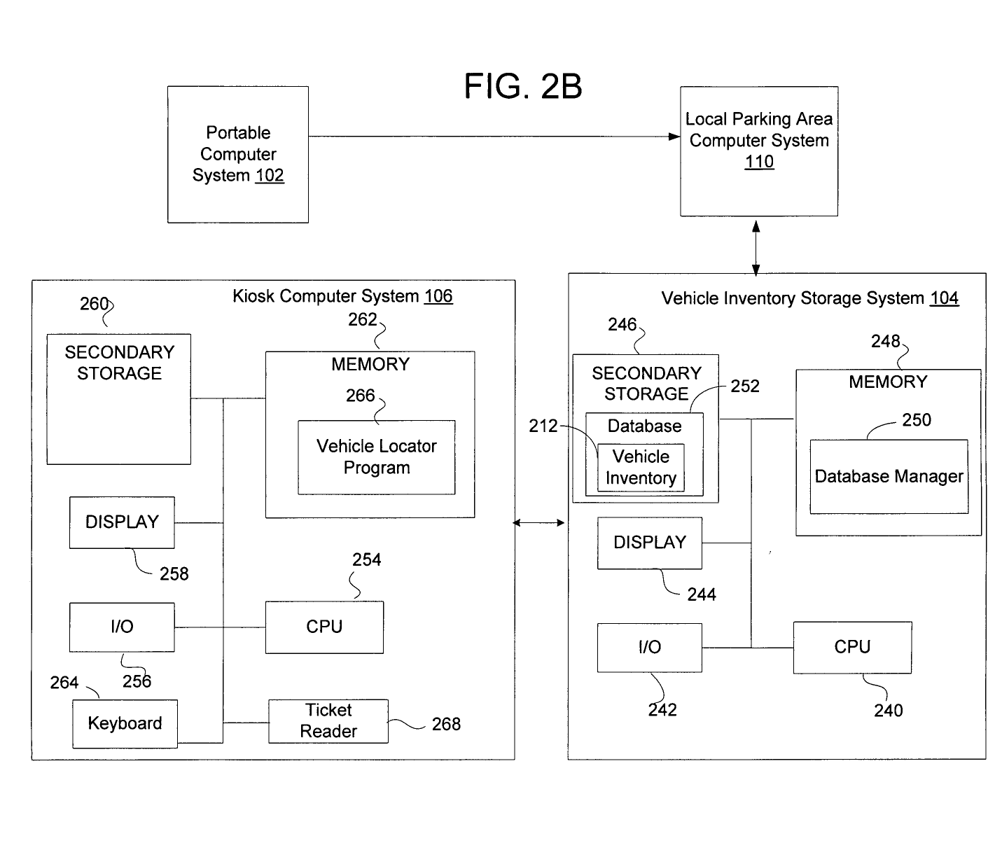

In the implementation shown in FIG. 1, the vehicle inventory gathering system 102 includes a portable computer system 108 and a local parking area computer system 110 that is operatively connected between the portable computer system 108 and the vehicle inventory storage system 104. In this implementation, the vehicle inventory gathering system 102 receives the vehicle identifier 52 associated with the vehicle 50 via an attendant 112 or operator of the portable computer system 108. The attendant 112 visually captures the vehicle identifier 52 of the parked vehicle 50 and enters the vehicle identifier 52 into portable computer system 108 in accordance with a vehicle inventory manager program 212 (in FIG. 2) in the portable computer system 108. As further described below, the vehicle inventory gathering system 102 may receive the location identifier 52 corresponding to a location where the vehicle is parked via manual input from the attendant 112, via GPS Satellite 114 positioning, or via scanning a bar code that reflects the location identifier 52.

FIG. 2 depicts an illustrative example of the portable computer system 108, the local parking area computer system 110, the vehicle inventory storage system 104, and the kiosk computer system 106 suitable for use in the data processing system 100. The portable computer system 108 may be a personal data assistant, a pocket PC, a laptop PC, or other portable device comprising a central processing unit (CPU) 202, an input/output (I/O) unit 204, a display device 206, a secondary storage device 208, and a memory 210. The portable computer system 108 may further comprise standard input devices such as a keyboard, a mouse or a speech processing means (each not illustrated).

Memory 210 includes the vehicle inventory manager program 212 operatively configured to capture the inventory of vehicles parked in the area 60 (i.e., vehicle inventory 214) in accordance with methods consistent with present invention so that a user may subsequently locate a vehicle of interest (e.g., vehicle 51) using the kiosk computer system 106. Vehicle inventory 214 may be stored by the vehicle inventory manager 212 in memory 210 or secondary storage 208. Alternatively, vehicle inventory 214 may be transferred for storage in the local parking area computer system 110 for accounting processing before transfer to the remote vehicle inventory storage system 104 that is operatively connected to the kiosk computer system 106. Vehicle inventory 214 includes one or more vehicle inventory information entries or records 216 and 218. Each record 216 and 218 corresponds to a respective zone 70 or 80 or parking space 72, 74, 76, 82, or 84 in the area 60 in which a respective vehicle 50 is parked. As shown in FIG. 2, each vehicle inventory information record 216 and 218 may include the vehicle identifier 216a and 218a, an approximate date 216b and 218b when the vehicle 50 entered or parked in the area 60, an approximate time 216c and 218c when the vehicle 50 entered or parked in the area 60, an image 216d and 218d of the vehicle 50 for verification by the user, and the inventoried location identifier 90 or 97 associated with the vehicle identifier 52. In one implementation, the attendant 112 may manually input the date 216b and 218b and the approximate time 216c and 218 into the portable computer system 108 when inventorying the parked vehicle 50. In another implementation, the date 216b or 218b and the time 216c or 218c may be captured manually or automatically using the local parking area computer system 110 when the vehicle 50 initially enters the area 60 as discussed below.

The portable computer system 108 may also include a global positioning system (GPS) receiver 220, such as a GPSMAP 76CS commercially available from Garmin or eXplorist 600 commercially available from Magellan®. In one implementation, the GPS receiver 220 is operably connected to the portable computer system 108 via I/O unit 204. The GPS receiver 220 functions in cooperation with globally positioned satellites to derive a current position in latitude and longitude using a standard triangulation technique. The vehicle inventory manager 212 is operatively configured to receive the current position in latitude and longitude derived by the GPS receiver. In one implementation, each of the zones 70 and 80 or parking spaces 72, 74, 76, 82 and 84 are initially determined by the vehicle inventory manager 212 to correspond to one of a plurality of latitudes and one of a plurality of longitudes using the GPS receiver 220 or other known geographical positioning systems. Accordingly, the vehicle inventory manager 212 is able to recognize that the latitude and the longitude derived for each zone 70 and 80 or parking spaces 72, 74, 76, 82 and 84 also corresponds to the location identifier 90, 92, 94, 96, 97, 98 or 99 associated with or marking the respective zone 70 or 80 or parking space 72, 74, 76, 82 or 84. Subsequently, when performing a vehicle inventory process as discussed herein, the vehicle inventory manager 212 is operatively configured to receive a current latitude and a current longitude from the GPS receiver 220 when the GPS receiver is positioned in proximity to a parked vehicle 50 and to determine the one location identifier 90 or 97 associated with the parked vehicle 50 based on the current latitude and the current longitude.

The portable computer system 108 may also include a bar code reader 222, such as a pen or wand type reader, and camera-based reader, or other standard bar code reader. The bar code reader 222 may be integrated to plug into the backplane bus of the portable computer system or communicate through the I/O unit 204 via an RS232 connection or other standard I/O connection (not shown in figures) for a personal computer. In one implementation, a location identifier 92 may be incorporated into a bar code positioned in proximity to one 80 of the plurality of zones associated with the one location identifier 92. In this implementation, the vehicle inventory manager 212 is operatively configured to obtain or receive the location identifier 92 from the bar code reader 222 when the wand or camera (not shown in figures) is positioned such that the bar code reader 222 is able to capture the bar code and derive the location identifier 92 incorporated within the bar code.

The local parking area computer system 110 may be, for example, a Sun SPARC® data processing system running the Solaris® operating system. The customer system local parking area computer system 110 comprises a CPU 224, an I/O unit 226, a display device 228, a secondary storage device 230, and a memory 232. Memory 232 has a vehicle parking fee account manager 234 that allows the owner of the parking area 60 to utilize the gathered vehicle inventory 214 to process parking accounts 236 for each vehicle 50 identified in the vehicle inventory 214 before or in concurrence with transferring the vehicle inventory 214 to the vehicle inventory storage system 104 for locating a vehicle within the area 60 upon request from a user operating the kiosk computer system 106 in accordance with the present invention.

As shown in FIG. 1, the data processing system 100 may include a wireless reader 118, such as the “ALR-2850 Long Range Battery Assisted Passive RF ID Reader” commercially available from Alien Technology@, adapted to receive and decode a vehicle identifier 62 from a signal transmitted by an RF modem or transponder mounted in or on a vehicle 60 when the vehicle is entering the parking area 60. The wireless reader 118 is operatively connected to the vehicle parking fee account manager 234 via I/O unit 226 so the vehicle parking fee account manager 234 (or the vehicle inventory manager 212 hosted on the local parking area computer system) may automatically capture the date 216b, 218b and the time 216c, 218c when each vehicle 50, 60 initially enters the area 60 and initializes the vehicle inventory 214 accordingly.

The data processing system 100 may also include a camera 120 disposed to capture an image of the vehicle identifier, such as a license tag, on each vehicle 50, 60 entering the parking area 60. In this implementation, memory 232 may include a vehicle identifier recognition program 238 operatively configured to receive the image captured for a respective vehicle 50, 60 and to store the image in the vehicle inventory 214 as the image 216d, 218d of the vehicle 50 for verification by the user when using the kiosk computer system 106 to locate where the vehicle 50 is parked within the area. The vehicle identifier recognition program 238 may use a standard optical character recognition technique to obtain or recognize the vehicle identifier (e.g., vehicle identifier 62 from the image in which the vehicle identifier was captured (e.g., image 216d). In this implementation, the vehicle parking fee account manager 234 may capture and initialize the date 216b, 218b and the time 216c, 218c in the vehicle inventory 214 when each vehicle 50, 60 initially enters the area 60 based on when the vehicle identifier 216a, 218a is captured in the image 216d, 218d.

The data processing system 100 may further include a ticket printer/encoder 122 operatively connected to the local parking area computer system 110 via I/O unit 226 such that the vehicle parking fee account manager 234 or the vehicle inventory manager 212 hosted in memory 232 prompts the ticket printer/encoder 122 to generate a ticket 124 having the vehicle identifier 52, 62 printed or encoded thereon when the vehicle 50, 60 enters the parking area 60. In accordance with methods consistent with the present invention as described herein, the user of the vehicle 50, 60 may provide the ticket 124 to the kiosk computer system 106 to initiate a request for the kiosk computer system to locate the vehicle 50, 60 for the user.

In one implementation, the local parking area computer system 110 may be incorporated into the vehicle inventory storage system 104, which may be incorporated into the kiosk computer system 106 such that the portable computer system 108 is operatively connected directly with the kiosk computer system 106. In this implementation, the wireless reader 118, the camera 120, and the ticket printer/encoder 122 are each operatively connected to the kiosk computer system 106.

Referencing FIG. 2B, the vehicle inventory storage system 104 and the kiosk computer system 106 may each be, for example, a Sun SPARC® data processing system running the Solaris® operating system, an IBM compatible, Apple, or other equivalent general-purpose computer system. The vehicle inventory storage system 104 comprises a CPU 240, an I/O unit 242, a display device 244, a secondary storage device 246, and a memory 248. The vehicle inventory storage system 104 may further comprise standard input devices such as a keyboard, a mouse or a speech processing means (each not illustrated). Memory 248 comprises a database manager 250, such as a standard relational database system manager, that is operatively configured to receive the vehicle inventory 212 from the local parking area computer system 110 or 310 and to incorporate the vehicle inventory 212 into a database 252 stored in secondary storage 246 or memory 248.

As shown in FIG. 2B, the kiosk computer system 106 also comprises a CPU 254, an I/O unit 256, a display device 258, a secondary storage device 260, and a memory 262. The kiosk computer system 106 also includes a keyboard 264 or other standard input device, such as a mouse, touch screen or a speech processing means. Memory 266 comprises a vehicle locator 266 program operatively connected to the database manager 250. As discussed in further detail below, in response to a user request, the vehicle locator 266 is operatively configured to retrieve the location identifier (e.g., location identifier 90) corresponding to the location (e.g. zone 70 or parking space 76) where a vehicle is parked based on at least a portion of the vehicle identifier 52 provided as part of the user request.

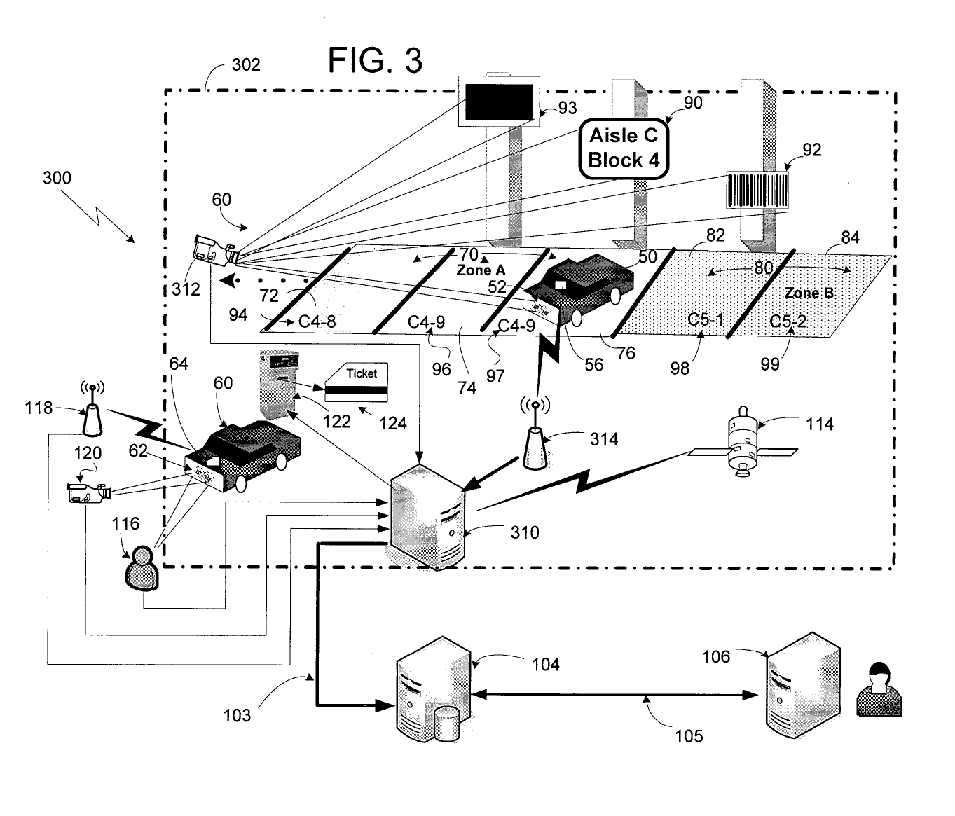

FIG. 3 depicts a block diagram of another exemplary data processing system 300 suitable for locating a vehicle (e.g., vehicle 50) parked in the area 60 in accordance with the present invention. Similar to the data processing system 100, the data processing system 300 includes a vehicle inventory gathering system 302, a vehicle inventory storage system 104 operatively connected to the vehicle inventory gathering system 302 via a first network connection 103, and a kiosk computer system 106 operatively connected to the vehicle inventory storage system via a second network connection 105. In the implementation shown in FIG. 3, the vehicle inventory gathering system 302 includes a local parking area computer system 310 operatively connected to the vehicle inventory storage system 104 to automatically capture or receive the vehicle identifier 52 of each vehicle 50 parked in the area 60 and the location identifier corresponding to the location (e.g., zone 90 or parking space 97) where the vehicle 50 is parked.

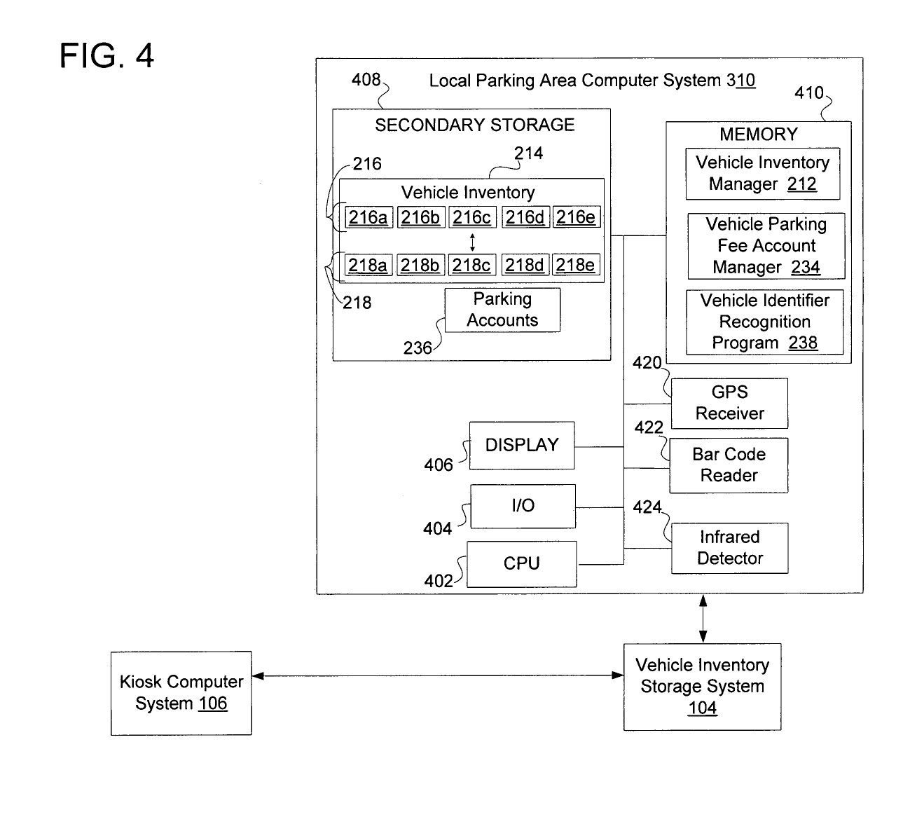

FIG. 4 depicts an illustrative example of the local parking area computer system 310 suitable for use in the data processing system 300. The local parking area computer system 310 may be, for example, a Sun SPARC® data processing system running the Solaris® operating system, an IBM compatible, Apple, or other equivalent general-purpose computer system. The local parking area computer system 310 comprises a CPU 402, an I/O unit 404, a display device 406, a secondary storage device 408, and a memory 410. The local parking area computer system 310 may further comprise standard input devices such as a keyboard, a mouse, touch screen or a speech processing means (each not illustrated).

Memory 410 includes the vehicle inventory manager program 212 operatively configured to capture the inventory of vehicles parked in the area 60 (i.e., vehicle inventory 214) in accordance with methods consistent with present invention so a user may subsequently locate a vehicle of interest (e.g., vehicle 51) using the kiosk computer system 106. Vehicle inventory 214 may be stored by the vehicle inventory manager 212 in memory 410 or secondary storage 408. Alternatively, vehicle inventory 214 may be transferred to the remote vehicle inventory storage system 104 operatively connected to the kiosk computer system 106.

In one implementation, the local parking area computer system 310 may be a portable or mobile computer. In this implementation, the local parking area computer system 310 may include a GPS receiver 420 that functions in cooperation with globally positioned satellites 114 to derive a current position in latitude and longitude using a standard triangulation technique. The vehicle inventory manager 212 when run by the CPU 402 is operatively configured to receive the current position in latitude and longitude derived by the GPS receiver 420. In one implementation, each of the each of the zones 70 and 80 or parking spaces 72, 74, 76, 82 and 84 are initially determined by the vehicle inventory manager 212 to correspond to one of a plurality of latitudes and one of a plurality of longitudes using the GPS receiver 420 or other known geographical positioning system. Accordingly, the vehicle inventory manager 212 is able to automatically recognize that the latitude and the longitude derived for each zone 70 and 80 or parking spaces 72, 74, 76, 82 and 84 also corresponds to the location identifier 90, 92, 94, 96, 97, 98 or 99 associated with or marking the respective zone 70 or 80 or parking space 72, 74, 76, 82 or 84. Subsequently, when performing a vehicle inventory process as discussed herein, the vehicle inventory manager 212 is operatively configured to receive a current latitude and a current longitude from the GPS receiver 420 when the GPS receiver is positioned in proximity to a parked vehicle 50 and to determine the one location identifier 90 or 97 associated with the parked vehicle 50 based on the current latitude and the current longitude.

The local parking area computer system 310 may also include a bar code reader 422 to automatically capture the location identifier 92 associated with the zone 80 or parking space 82, 84 in which a vehicle is parked. In one implementation, the bar code reader 422 may be operatively connected to a camera 312 via the I/O unit 404. In this implementation, a location identifier 92 may be incorporated into a bar code positioned in proximity to one 80 of the plurality of zones associated with the one location identifier 92. In this implementation, the vehicle inventory manager 212 is operatively configured to obtain or receive the location identifier 92 from the bar code reader 422 when the camera 312 is positioned to capture an image of the bar code for the location identifier 92 such that the bar code reader 422 is able to derive the location identifier 92 incorporated within the bar code.

In another implementation, the vehicle identifier 52 may be incorporated in an infrared tag (e.g., the license tag) on the vehicle. In addition, one or more of the location identifiers (e.g., location identifier 93 in FIG. 3) may be incorporated in an infrared tag positioned in proximity to the one zone 70 or parking space 74 associated with the one location identifier 93. In either of these implementations, the local parking area computer system 310 includes an infrared detector 424 operatively connected to the camera 312 via the I/O unit 404. In this implementation, the vehicle inventory manager 212 is operatively configured to obtain or receive the location identifier 92 from the infrared detector 424 when the camera 312 is positioned to capture the infrared tag associated with either the vehicle identifier 52 or the location identifier 93 such that the bar code reader 422 is able to derive the vehicle identifier 52 and the location identifier 92 from the respective infrared tags.

In another implementation, when the vehicle identifier 52 is a license tag, the camera 312 may be incorporated in a known mobile license plate recognition system, such as the Model P390 recognition system commercially available from Pips Technology. In this implementation, the vehicle inventory manager 212 is operatively configured to obtain or receive the vehicle identifier 90 from the mobile license plate recognition system when the camera 312 is move into a position where an image of the vehicle identifier 52 may be captured by the camera 312.

Alternatively, the camera 312 may be disposed in relation to or moved in proximity to a parked vehicle 52 such that the camera is able to capture an image of a location identifier 90 associated with the zone 70 or parking space 76 where the vehicle 50 is parked. In this implementation, memory 410 may include a vehicle identifier recognition program 238 operatively configured to receive the image captured for the vehicle 50 and to store the image in the vehicle inventory 214 as the image 216d, 218d of the vehicle 50 for verification by the user when using the kiosk computer system 106 to locate where the vehicle 50 is parked within the area. The vehicle identifier recognition program 238 may use a standard optical character recognition technique to obtain or recognize the vehicle identifier (e.g., vehicle identifier 62 from the image in which the vehicle identifier was captured (e.g., image 216d). In this implementation, the vehicle inventory manager 212 may obtain or receive the vehicle identifier 52 from the vehicle identifier recognition program and store the vehicle identifier 52 in a corresponding record 216, 218 in the vehicle inventory 214.

In yet another implementation, the data processing system 300 may include a wireless reader 314, such as the “ALR-2850 Long Range Battery Assisted Passive RF ID Reader” commercially available from Alien Technology®, that is adapted to receive and decode a vehicle identifier 52 from a signal transmitted by an RF modem or transponder 56 mounted in or on a vehicle 50 parked in the area 60. The wireless reader 314 is operatively connected to the vehicle inventory manager 212 via I/O unit 404 so the vehicle inventory manager 234 may automatically capture the vehicle identifier 52.

As shown in FIG. 3, the data processing system 300 may also include the wireless reader 118 and the camera 120 operatively connected to the vehicle inventory manager 212 (in lieu of or in addition to the vehicle parking fee account manager 234 of system 100), allowing the vehicle inventory manager 212 to automatically capture the date 216b, 218b and the time 216c, 218c when each vehicle 50, 60 initially enters the area 60.

In addition, the data processing system 300 may include a ticket printer/encoder 122 operatively connected to the local parking area computer system 310 via I/O unit 404 such the vehicle inventory manager 212 prompts the ticket printer/encoder 122 to generate a ticket 124 having the vehicle identifier 52, 62 printed or encoded thereon when the vehicle 50, 60 enters the parking area 60.

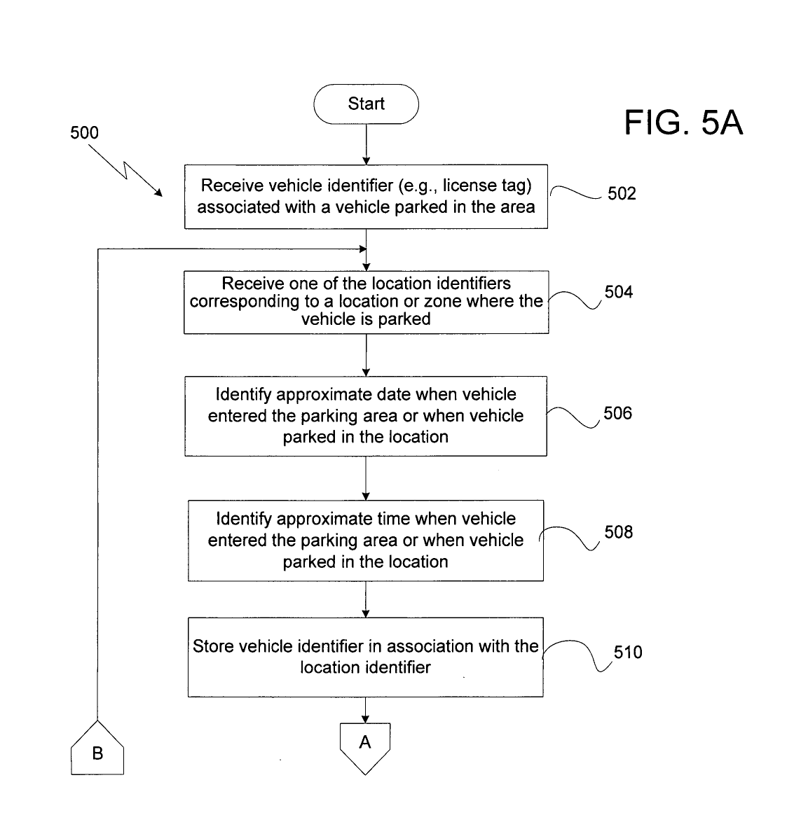

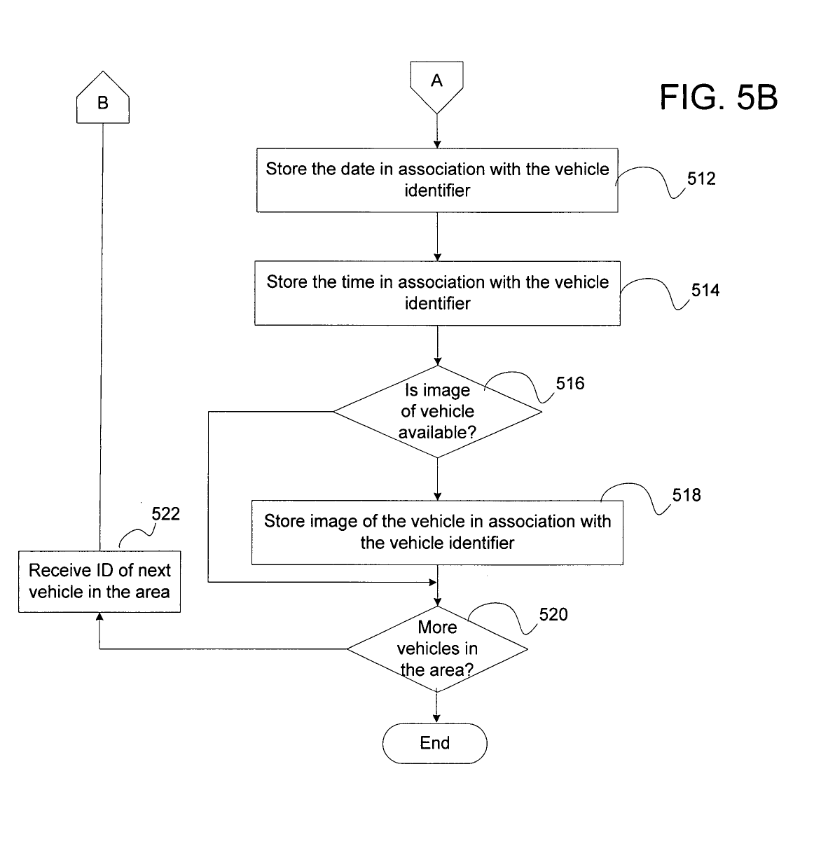

FIGS. 5A-5B depict a flow diagram illustrating a process 500 performed by the vehicle inventory manager 212 program in the data processing system 100 and 300 to inventory vehicles parked in an area 60. Initially, the vehicle inventory manager 212 receives a vehicle identifier (e.g., license tag) of a vehicle parked in the area 60 (step 502). In the implementation shown in FIG. 1, the vehicle inventory manager 212 may receive the vehicle identifier 52 of the parked vehicle 50 via the attendant 112 manually inputting the vehicle identifier 52 into the portable computer system 108 after the attendant observes that the vehicle 50 is parked in the one location identifier 90 corresponding to the zone. In the implementation shown in FIGS. 3 and 4, the vehicle inventory manager 212 may automatically receive the vehicle identifier 52 of the parked vehicle 50 via the wireless reader 314, which receives and decodes the vehicle identifier 52 in a signal transmitted by the RF modem or transponder 56 mounted in or on the parked vehicle 50. Alternatively, the vehicle inventory manager 212 may automatically receive the vehicle identifier 52 of the parked vehicle 50 via the infrared detector 424 when the camera 312 is configured for infrared imaging and positioned to capture the infrared tag associated with the vehicle identifier 52. In addition, the vehicle inventory manager 212 may automatically receive the vehicle identifier via the camera 312 when the camera 312 is incorporated in a camera mobile license plate recognition system.

Next, the vehicle inventory manager 212 receives one of the location identifiers corresponding to a location where the vehicle is parked (step 504). In the implementation shown in FIG. 1, the vehicle inventory manager 212 may receive the location identifier 90 corresponding to the zone 70 or space 76 where the vehicle 50 is parked via the attendant 112 manually inputting the location identifier 90 or 97 into the portable computer system 108 after observing the vehicle 50 is parked in proximity to the one location identifier 90 or 97. In the data processing system 100 and 300, the vehicle inventory manager 212 may automatically receive the location identifier 52 of the parked vehicle 50 via the bar code reader 222, 422 when the location identifier 52 is incorporated in a bar code positioned in proximity to the zone or parking space corresponding to the location identifier 52. Alternatively, the vehicle inventory manager 212 may automatically receive the location identifier 52 of the parked vehicle 50 via the GPS receiver 220 or 420 when the GPS receiver 220 or 420 is positioned in proximity to the parked vehicle 50 so the GPS receiver 220 or 420 derives the current latitude and the current longitude from signals received from GPS satellites 114 using a standard triangulation technique. In the implementation shown in FIGS. 3 and 4, the vehicle inventory manager 212 may automatically receive the location identifier 52 of the parked vehicle 50 via the infrared detector 424 when the camera 312 is configured for infrared imaging and is positioned to capture the infrared tag associated with the location identifier 93. In addition, the vehicle inventory manager 212 may automatically receive the location identifier via the camera 312 when the camera 312 is incorporated in a camera mobile license plate recognition system as previously discussed.

Returning to FIG. 5A, the vehicle inventory manager 212 also may identify the approximate date (step 506) and the approximate time (step 508) when the vehicle 50 entered the area 60 or when the vehicle 50 parked in the location or zone corresponding to the received location identifier In one implementation. In one implementation, an attendant 112 or 116 observe when the vehicle 50 entered the area 60 and manually input the corresponding date and the time via the local parking area computer 110 or 310 or via the portable computer system 108. Similarly, an attendant 112 or 116 may observe approximately when the vehicle 50 parked in the area 60 and manually input the corresponding date and the time via the local parking area computer 110 or 310 or via the portable computer system 108. Alternatively, the vehicle inventory manager 212 may automatically identify the approximate date and the approximate time of entry or parking in the area based on when the wireless reader 118 received and decoded the respective vehicle identifier 52 from a signal transmitted by the RF modem or transponder 56 mounted in or on the vehicle 50. In addition, the vehicle inventory manager 212 may automatically identify the approximate date and the approximate time of entry or parking in the area based on when the camera 120 captured the image of the vehicle identifier 52 on the respective vehicle 50 entering the parking area 60. The vehicle identifier recognition program 238 may use a standard optical character recognition technique to obtain or recognize the vehicle identifier 52.

Next, the vehicle inventory manager 212 stores the location identifier 52 in association with the vehicle identifier 52 (step 510). The vehicle inventory manager 212 stores each location identifier with the associated vehicle identifier 52 as an item 216a or 218a in a respective record 216 or 218 in the vehicle inventory 214. The vehicle inventory 214 is stored in a database 252 or other secondary storage 246 file that is accessible by the kiosk computer system 106.

The vehicle inventory manager 212 may also store the identified date (step 512) and the identified time in association with the vehicle identifier (step 514). The identified date and identified time may be stored in the vehicle inventory information record 216 and 218 in which the corresponding vehicle identifier 216a and 218a is stored.

The vehicle inventory manager 212 then determines whether there is an image of the vehicle available (step 516). In one implementation, the vehicle inventory manager 212 determines that an image of the vehicle 50 is available when the vehicle identifier 52 associated with the vehicle 50 is automatically received by the vehicle inventory manager from the camera 312 positioned to capture an image of the vehicle identifier on the vehicle 50 when the vehicle 50 enters the area 60 or is parked in the area 60.

If there is not an image of the vehicle available, the vehicle inventory manager 212 continues processing at step 520. If there is an image of the vehicle available, the vehicle inventory manager 212 stores the image of the vehicle in association with the vehicle identifier (step 518). For example, the image of the vehicle 50 captured by the camera 312 when the vehicle 50 entered the area 60 may be stored as an item 216d or 216d in the vehicle inventory information record 216 and 218 in which the corresponding vehicle identifier 216a and 218a is stored.

Next, the vehicle inventory manager 212 determines whether there are more vehicles in the parking area 60 (step 520). In one implementation, the attendant 112 may identify to the vehicle inventory manager 212 that there are no more vehicles in the parking area by actuating a dedicated key or menu selection (each not shown in the figures) on the portable computer system 108 or the local parking area computer system 310 where the vehicle inventory manager 212 is hosted.

If there are more vehicles in the parking area 60, the vehicle inventory manager 212 receives the vehicle identifier of another vehicle in the area 60 (step 522) as discussed above in relation to step 502 before continuing processing at step 504.

Accordingly, the vehicle inventory manager 212 is able to generate and maintain a vehicle inventory 214 of vehicles parked in the area so that a user (e.g., a driver or security officer) may request the kiosk computer system 106 to locate where a specific vehicle (e.g., vehicle 50) is parked in the area 60.

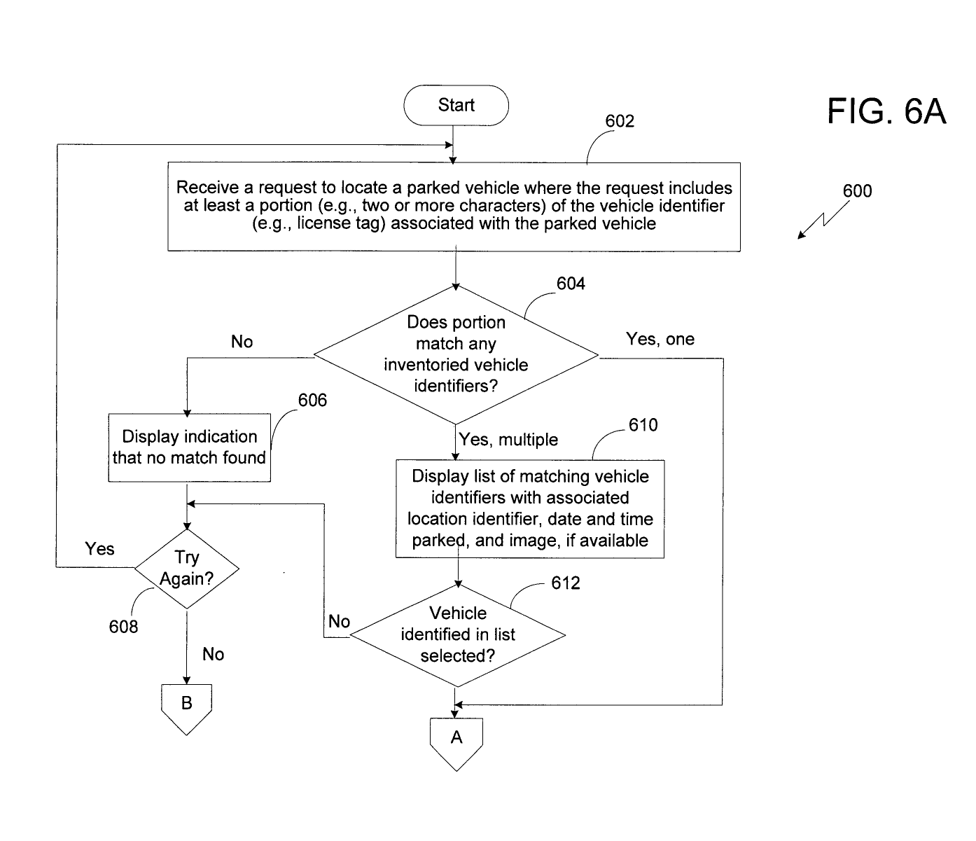

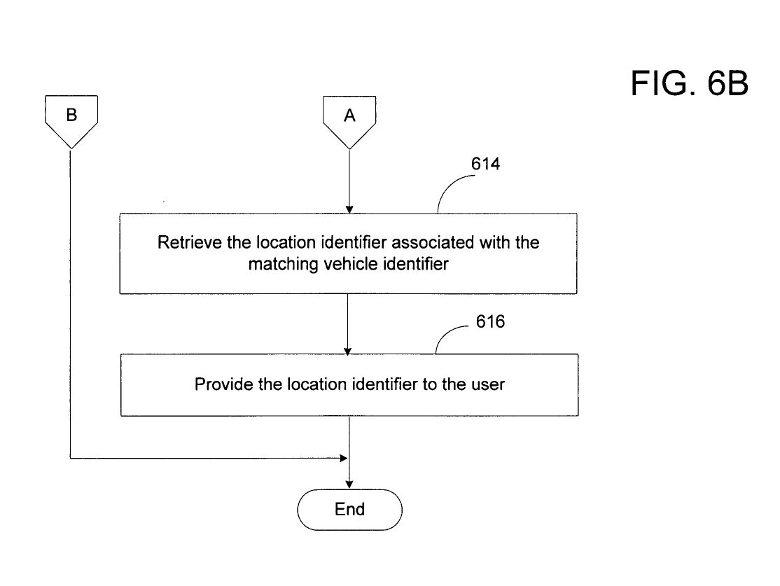

FIGS. 6A-6B depict a flow diagram illustrating a process 600 performed by the vehicle locator program 266 in the kiosk computer system 106 to locate one vehicle from among the inventoried vehicles parked in the area in accordance with a user request.

Initially, the vehicle locator 266 receives a request to locate a parked vehicle within the area where the request includes at least a portion (e.g., two or more characters) of the vehicle identifier (e.g., license tag) associated with the parked vehicle (step 602). A driver or user of the vehicle 50 may not recall all the characters in the vehicle identifier 52 (e.g., the license tag) associated with the driver's vehicle. Accordingly, in one implementation, the driver or other user interested in locating the parked vehicle 50 may initiate the request to locate the parked vehicle 50 by inputting all or a portion of the vehicle identifier 52 associated with the vehicle 50 via the keyboard 264 or other input device of the kiosk computer system 106. In another implementation, the driver or user may insert the ticket 124 encoded with the vehicle identifier 52 into the ticket reader 268 of the kiosk computer system 106 to initiate the request and provide the vehicle locator 266 with the entire vehicle identifier 52.

Next, the vehicle locator 266 determines whether the received portion matches any of the inventoried vehicle identifiers stored in the vehicle inventory 212 (step 604). If the received portion does not match any of the inventoried vehicle identifiers, the vehicle locator 266 displays an indication (not shown in figures) that no match was found (step 606) and determines whether the user wants to try to input the vehicle identifier again (step 608). If the user wants to try again, the user may start inputting all or a portion of the vehicle identifier causing the vehicle locator 266 to continue processing at step 502. The user may actuate a designated key on the keyboard 264 or do nothing for a predetermined period to signal to the vehicle locator 266 that the user does not want to try again and ends processing.

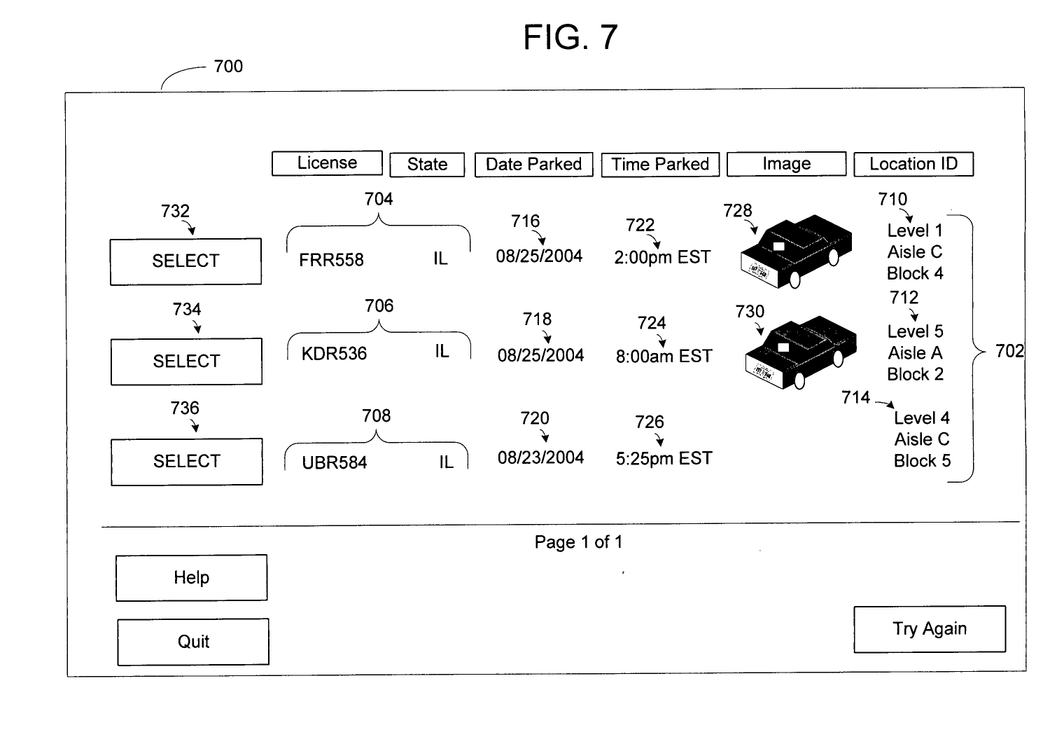

If the vehicle locator 266 determines the received portion matches more than one of the inventoried vehicle identifiers stored in the vehicle inventory 212, the vehicle locator displays a list of the matching vehicle identifiers with associated location identifier (step 610). FIG. 7 depicts an exemplary user interface screen 700 generated by the vehicle locator 266 to display the list 702 of the matching vehicle identifiers 704, 706, and 708 with the associated location identifiers 710, 712, and 714. By retrieving the record 216 or 218 corresponding to each matching vehicle identifier 704, 706, and 708 in the vehicle inventory 214, the vehicle locator 266 is also able to identify and display the date 716, 718, and 720 and the time 722, 724, 726 each vehicle identified in the list 702 entered or parked in the area 60 so the user may select one of the displayed vehicle identifiers 704, 706, and 708 based on the user's recollection of the date and time when the user's vehicle was driven into or parked within the area 60. For example, a driver parking a vehicle at an airport may not recall all the characters in the license tag of the driver's vehicle but may recall the approximate date and time the vehicle was driven into the parking area. If the retrieved record 216 or 218 includes an image 216d or 218d corresponding to a respective matching vehicle identifier 704, 706, and 708, the vehicle locator 266 is also able to display the image 728 and 730 of the vehicle stored in association with a respective matching vehicle identifier 716 and 718 so the driver or user of the vehicle may select one of the matching vehicle identifiers based on the image 728 or 730 of the vehicle.

Returning to FIG. 6A, the vehicle locator 266 determines whether the user has selected one of the matching vehicle identifiers 704, 706, and 708 in the list 702 (step 612). In one implementation, the user selects one of the matching vehicle identifiers 704, 706, and 708 by selecting a corresponding button 732, 734, and 736 on the user interface screen 700.

If the vehicle locator 266 determines the received portion matches one of the inventoried vehicle identifiers stored in the vehicle inventory 212 in step 504 or one of the matching vehicle identifiers 704, 706, and 708 in the list 702 is selected, the vehicle locator 266 retrieves the location identifier associated with the single or selected matching vehicle identifier (step 614) from the corresponding record 216 or 218 in the vehicle inventory 214 and provides the retrieved location identifier to the user (step 616) before ending processing.

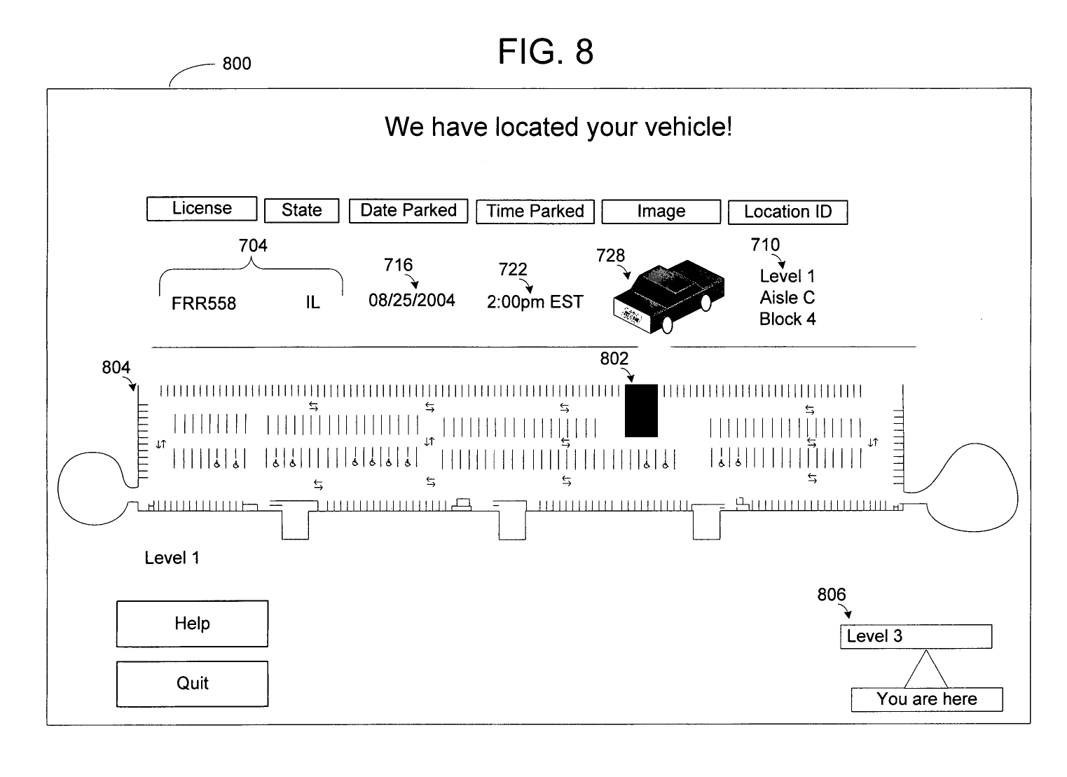

FIG. 8 depicts an exemplary user interface screen 800 displayed by the vehicle locator 266 when a single vehicle identifier matching the user request is identified or a matching vehicle identifier is selected from the list 702. In the example shown in FIG. 8, the vehicle locator 266 displays the identified or selected matching vehicle identifier 704 in association with the location identifier 710 so that the user can locate the vehicle 50 within the area 60. In the implementation shown in FIG. 8, the vehicle locator 266 also displays a graphical representation 802 of the zone 70 or parking space 76 corresponding to the location identifier 710 in relation to a map 804 of the area 60 so the user may visualize where to locate the vehicle 50.

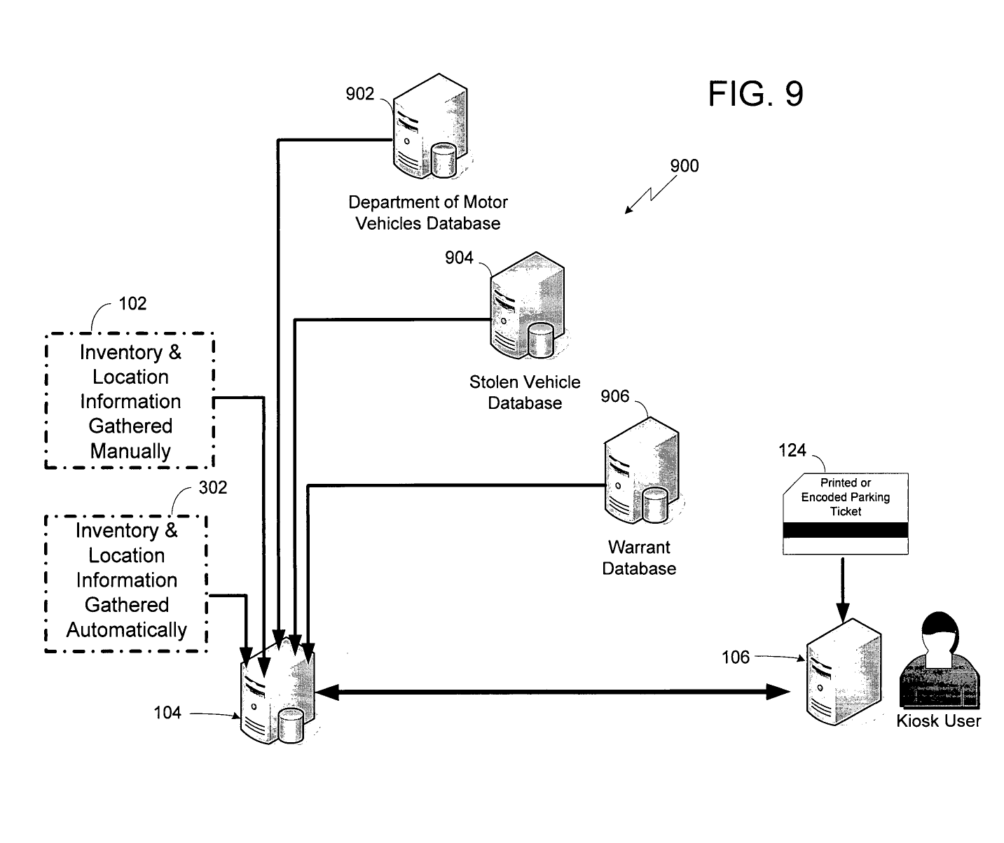

FIG. 9 is a block diagram of a third exemplary data processing system 900 suitable for locating a vehicle (e.g., vehicle 50) parked in the area 60 in accordance with the present invention. The data processing system 900 includes both the vehicle inventory gathering system 102 and the vehicle inventory gathering system 302, each of which is operatively connected to the vehicle inventory storage system 104 so that vehicle inventory 212 generated by the vehicle inventory manager 212 in each gathering system 102 and 302 may be transferred and compiled together in the vehicle inventory storage system 104. The data processing system 900 also includes a kiosk computer system 106 operatively connected to the vehicle inventory storage system 104. The data processing system 900 also includes a Department of Motor Vehicles (DMV) database system 902, which stores the name of each registered vehicle owner with a corresponding license plate number or vehicle identifier. The vendor locator 266 program in the kiosk computer system 106 of the data processing system 900 is operatively configured to receive an owner's name, preferably from an authorized agent (e.g., a law enforcement officer, or parking attendant) as part of the owner's request to locate a vehicle within the parking area. In response to receiving the owner's name, the vendor locator 266 is operatively configured to retrieve the license tag or vehicle identifier registered to the owner from the DMV database system 902 and use the retrieved vehicle identifier in step 602 of process 600 to locate the vehicle from among the inventoried vehicles parked in the area (e.g., vehicle inventory 214). Thus, the vendor locator 266 in the kiosk computer system 106 allows the owner of a vehicle parked in the area 60 to locate the vehicle within the area without requiring the owner to recall any portion of the vehicle identifier.

As shown in FIG. 9, the data processing system 900 may also include a stolen vehicle database system 904 operatively connected directly to the vehicle locator 266 of the kiosk computer system 106 or via the vehicle inventory storage system 104. The stolen vehicle database system 904 may be a database system maintained by a local, state, or federal law enforcement agency. In this implementation, in response to identifying a matching vehicle identifier in the vehicle inventory 214 in step 604 or 612 of process 600, the vehicle locator 266 is operatively configured to determine whether the matching vehicle identifier corresponds to one of the stolen vehicle identifiers or license plate tags included in the stolen vehicle database system. In response to determining that the matching vehicle identifier corresponds to one of the stolen vehicle identifiers in the stolen vehicle database system, the vehicle locator 266 is further configured to automatically notify the law enforcement agency maintaining the stolen vehicle database system 904 that the vehicle associated with the one stolen vehicle identifier is parked in the area 60 at the location identifier stored with the matching vehicle identifier in the vehicle inventory 214.

As shown in FIG. 9, the data processing system 900 may also include an outstanding warrant database system 906 operatively connected directly to the vehicle locator 266 of the kiosk computer system 106 or via the vehicle inventory storage system 104. The outstanding database system 906 includes a plurality of vehicle identifiers each associated with a respective owner having an outstanding warrant, such as a warrant for unpaid parking tickets.

The outstanding warrant database system 906 may be a database system maintained by a local, state, or federal law enforcement agency. In this implementation, in response to identifying a matching vehicle identifier in the vehicle inventory 214 in step 604 or 612 of process 600, the vehicle locator 266 is operatively configured to determine whether the matching vehicle identifier corresponds to one of the vehicle identifiers included in the warrant database system 906. In response to determining the matching vehicle identifier corresponds to one of the vehicle identifiers in the warrant database system 906, the vehicle locator 266 is further configured to automatically notify the law enforcement agency maintaining the warrant database system 904 that the vehicle associated with the one vehicle identifier in the warrant database system 904 is parked in the area 60 at the location identifier stored with the matching vehicle identifier in the vehicle inventory 214.

One of skill in the art will appreciate that each program and module described herein can be a stand-alone program and can reside in memory on a data processing system other than the described systems 100 and 300. The program and modules may comprise or may be included in one or more code sections containing instructions for performing their respective operations. While the programs and modules are described as being implemented as software, the present implementation may be implemented as a combination of hardware and software or hardware alone. Also, one having skill in the art will appreciate that the programs and modules may comprise or may be included in a data processing device, which may be a client or a server, communicating with described systems.

Although aspects of methods, systems, and articles of manufacture consistent with the present invention are depicted as being stored in memory, one having skill in the art will appreciate that these aspects may be stored on or read from other computer-readable media, such as secondary storage devices, like hard disks, floppy disks, and CD-ROM; a carrier wave received from a network such as the Internet; or other forms of ROM or RAM either currently known or later developed. Further, although specific components of systems 100 and 300 have been described, one skilled in the art will appreciate that a data processing system suitable for use with methods, systems, and articles of manufacture consistent with the present invention may contain additional or different components.

The foregoing description of an implementation of the invention has been presented for purposes of illustration and description. It is not exhaustive and does not limit the invention to the precise form disclosed. Modifications and variations are possible in light of the above teachings or may be acquired from practicing of the invention. Additionally, the described implementation includes software but the present invention may be implemented as a combination of hardware and software or in hardware alone. Note also that the implementation may vary between systems. The claims and their equivalents define the scope of the invention.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

What is claimed is:

1. A method in a data processing system for locating a vehicle parked within an area, the area having a plurality of zones, each zone being associated with a respective one of a plurality of location identifiers, the method comprising:
receiving a vehicle identifier associated with the vehicle;
receiving one of the location identifiers corresponding to a location where the vehicle is parked;
storing the one location identifier in association with the vehicle identifier;
receiving a request to locate the parked vehicle within the area, the request including at least a portion of the vehicle identifier; and
retrieving the one location identifier in response to the request, based on at least the portion of the vehicle identifier.

2. A method as set forth in claim 1 wherein the step of receiving a vehicle identifier comprises receiving a manual input of the vehicle identifier after the vehicle is parked in one of the plurality of zones associated with the one location identifier.

3. A method as set forth in claim 1, wherein the step of receiving a vehicle identifier comprises:
receiving an image of the vehicle identifier on the vehicle; and
obtaining the vehicle identifier from the image using an optical character recognition technique.

4. A method as set forth in claim 3, wherein the image of the vehicle identifier on the vehicle is received after the vehicle is parked in the area and the step of receiving one of the location identifiers comprises:
receiving an image of the one location identifier in association with receiving the image on the vehicle; and
obtaining the one location identifier from the image using the optical character recognition technique.

5. A method as set forth in claim 1, wherein the vehicle identifier is incorporated in an infrared tag on the vehicle and the vehicle identifier is received using an infrared detector.

6. A method as set forth in claim 1, wherein the one location identifier is incorporated in an infrared tag positioned in proximity to one of the plurality of zones associated with the one location identifier and the one location identifier is received using an infrared detector.

7. A method as set forth in claim 1, wherein the one location identifier is incorporated in a bar code positioned in proximity to one of the plurality of zones associated with the one location identifier and the one location identifier is received using a bar code reader.

8. A method as set forth in claim 1, wherein the vehicle identifier is wirelessly transmitted from the vehicle and the vehicle identifier is received using a wireless reader after the vehicle enters the area.

9. A method as set forth in claim 1, wherein each of the plurality of location identifiers correspond to one of a plurality of latitudes and one of a plurality of longitudes, and the step of receiving one of the location identifiers comprises:
receiving a current latitude and a current longitude from a GPS receiver when the GPS receiver is positioned in proximity to the parked vehicle; and
determining the one location identifier based on the current latitude and the current longitude.

10. A method as set forth in claim 1, wherein the vehicle identifier is encoded on a ticket presented to a user of the vehicle when the vehicle enters the area, and the step of receiving a request to locate the parked vehicle comprises reading the encoded vehicle identifier from the ticket.

11. A method as set forth in claim 1, wherein the vehicle identifier is one of a plurality of inventoried vehicle identifiers stored in association with a respective one of the location identifiers, the method further comprising:
identifying an approximate date when the vehicle entered the area;
storing the identified date in association with the vehicle identifier;
in response to the request, determining whether the portion of the vehicle identifier matches more than one of the inventoried vehicle identifiers; and
when the portion of the vehicle identifier is determined to match more than one of the inventoried vehicle identifiers, displaying the vehicle identifier with the identified date stored in association with the vehicle identifier.

12. A method as set forth in claim 1, wherein the vehicle identifier is one of a plurality of inventoried vehicle identifiers stored in association with a respective one of the location identifiers, the method further comprising:
identifying an image of the vehicle;
storing the identified image in association with the vehicle identifier;
in response to the request, determining whether the portion of the vehicle identifier matches more than one of the inventoried vehicle identifiers; and
when the portion of the vehicle identifier is determined to match more than one of the inventoried vehicle identifiers, displaying the vehicle identifier with the identified image stored in association with the vehicle identifier.

13. A method as set forth in claim 1, wherein the vehicle identifier is one of a plurality of inventoried vehicle identifiers stored in association with a respective one of the location identifiers, the method further comprising:
in response to the request, determining whether the portion of the vehicle identifier matches more than one of the inventoried vehicle identifiers; and
when the portion of the vehicle identifier is determined to match more than one of the inventoried vehicle identifiers, displaying each of the matching inventoried vehicle identifiers.

14. A method as set forth in claim 13, further comprising:
receiving a selection of one of the displayed matching inventoried vehicle identifiers;
and in response to the selection, displaying the location identifier associated with the selected one of the displayed matching inventoried vehicle identifiers.

15. A method as set forth in claim 14, wherein the step of displaying the location identifier comprises displaying a graphical representation of the location identifier relative to a map of the area.

16. A method as set forth in claim 1, further comprising displaying a graphical representation of the retrieved location identifier relative to a map of the area.

17. A method as set forth in claim 1, wherein the step of receiving a vehicle identifier associated with the vehicle comprises:
receiving a name of an owner of the vehicle; and
identifying the vehicle identifier in a department of motor vehicles database using the name of the owner.

18. A method as set forth in claim 1, further comprising:
determining whether the vehicle identifier matches a stolen vehicle identifier in a stolen vehicle database maintained by a law enforcement agency; and
when it is determined that the vehicle identifier matches a stolen vehicle identifier, notifying the law enforcement agency that the vehicle is parked in the area at the one location identifier.

19. A method as set forth in claim 1, further comprising:
determining whether the vehicle identifier matches one of a second plurality of vehicle identifiers in a warrant database maintained by a law enforcement agency; and
when it is determined that the vehicle identifier matches one of the second plurality of vehicle identifiers in the warrant database, notifying the law enforcement agency that the vehicle is parked in the area at the one location identifier.

20. A computer-readable medium containing instructions for controlling a data processing system to perform a method for locating a vehicle parked within an area, the area having a plurality of zones, each zone being associated with a respective one of a plurality of location identifiers, the method comprising:
receiving a vehicle identifier associated with the vehicle;
receiving one of the location identifiers corresponding to a location where the vehicle is parked;
storing the one location identifier in association with the vehicle identifier;
receiving a request to locate the parked vehicle within the area, the request including at least a portion of the vehicle identifier; and
retrieving the one location identifier in response to the request, based on at least the portion of the vehicle identifier.

21. A computer-readable medium as set forth in claim 20 wherein the step of receiving a vehicle identifier comprises receiving a manual input of the vehicle identifier after the vehicle is parked in one of the plurality of zones associated with the one location identifier.

22. A computer-readable medium as set forth in claim 20, wherein the step of receiving a vehicle identifier comprises:
receiving an image of the vehicle identifier on the vehicle; and
obtaining the vehicle identifier from the image using a optical character recognition technique.

23. A computer-readable medium as set forth in claim 22, wherein the image of the vehicle identifier on the vehicle is received after the vehicle is parked in the area and the step of receiving one of the location identifiers comprises:
receiving an image of the one location identifier in association with receiving the image on the vehicle; and
obtaining the one location identifier from the image using the optical character recognition technique.

24. A computer-readable medium as set forth in claim 20, wherein the vehicle identifier is incorporated in an infrared tag on the vehicle and the vehicle identifier is received using an infrared detector.

25. A computer-readable medium as set forth in claim 20, wherein the one location identifier is incorporated in an infrared tag positioned in proximity to one of the plurality of zones associated with the one location identifier and the one location identifier is received using an infrared detector.

26. A computer-readable medium as set forth in claim 20, wherein the one location identifier is incorporated in a bar code positioned in proximity to one of the plurality of zones associated with the one location identifier and the one location identifier is received using a bar code reader.

27. A computer-readable medium as set forth in claim 20, wherein the vehicle identifier is wirelessly transmitted from the vehicle and the vehicle identifier is received using a wireless reader after the vehicle enters the area.

28. A computer-readable medium as set forth in claim 20, wherein each of the plurality of location identifiers correspond to one of a plurality of latitudes and one of a plurality of longitudes, and the step of receiving one of the location identifiers comprises:
receiving a current latitude and a current longitude from a GPS receiver when the GPS receiver is positioned in proximity to the parked vehicle; and
determining the one location identifier based on the current latitude and the current longitude.

29. A computer-readable medium as set forth in claim 20, wherein the vehicle identifier is encoded on a ticket presented to a user of the vehicle when the vehicle enters the area, and the step of receiving a request to locate the parked vehicle comprises reading the encoded vehicle identifier from the ticket.

30. A computer-readable medium as set forth in claim 20, wherein the vehicle identifier is one of a plurality of inventoried vehicle identifiers stored in association with a respective one of the location identifiers, the method further comprising:
identifying an approximate date when the vehicle entered the area;
storing the identified date in association with the vehicle identifier;
in response to the request, determining whether the portion of the vehicle identifier matches more than one of the inventoried vehicle identifiers; and
when the portion of the vehicle identifier is determined to match more than one of the inventoried vehicle identifiers, displaying the vehicle identifier with the identified date stored in association with the vehicle identifier.

31. A computer-readable medium as set forth in claim 20, wherein the vehicle identifier is one of a plurality of inventoried vehicle identifiers stored in association with a respective one of the location identifiers, the method further comprising:
identifying an image of the vehicle;
storing the identified image in association with the vehicle identifier;
in response to the request, determining whether the portion of the vehicle identifier matches more than one of the inventoried vehicle identifiers; and
when the portion of the vehicle identifier is determined to match more than one of the inventoried vehicle identifiers, displaying the vehicle identifier with the identified image stored in association with the vehicle identifier.

32. A computer-readable medium as set forth in claim 20, wherein the vehicle identifier is one of a plurality of inventoried vehicle identifiers stored in association with a respective one of the location identifiers, the method further comprising:
in response to the request, determining whether the portion of the vehicle identifier matches more than one of the inventoried vehicle identifiers; and
when the portion of the vehicle identifier is determined to match more than one of the inventoried vehicle identifiers, displaying each of the matching inventoried vehicle identifiers.

33. A computer-readable medium as set forth in claim 32, further comprising:
receiving a selection of one of the displayed matching inventoried vehicle identifiers; and in response to the selection, displaying the location identifier associated with the selected one of the displayed matching inventoried vehicle identifiers.

34. A computer-readable medium as set forth in claim 33, wherein the step of displaying the location identifier comprises displaying a graphical representation of the location identifier relative to a map of the area.

35. A computer-readable medium as set forth in claim 20, further comprising displaying a graphical representation of the retrieved location identifier relative to a map of the area.

36. A computer-readable medium as set forth in claim 20, wherein the step of receiving a vehicle identifier associated with the vehicle comprises:
receiving a name of an owner of the vehicle; and
identifying the vehicle identifier in a department of motor vehicles database using the name of the owner.

37. A computer-readable medium as set forth in claim 20, further comprising:
determining whether the vehicle identifier matches a stolen vehicle identifier in a stolen vehicle database maintained by a law enforcement agency; and
when it is determined that the vehicle identifier matches a stolen vehicle identifier, notifying the law enforcement agency that the vehicle is parked in the area at the one location identifier.

38. A computer-readable medium as set forth in claim 20, further comprising:
determining whether the vehicle identifier matches one of a second plurality of vehicle identifiers in a warrant database maintained by a law enforcement agency; and
when it is determined that the vehicle identifier matches one of the second plurality of vehicle identifiers in the warrant database, notifying the law enforcement agency that the vehicle is parked in the area at the one location identifier.

39. A data processing system for locating a vehicle parked within an area, the area having a plurality of zones, each zone being associated with a respective one of a plurality of location identifiers, the data processing system comprising:
a first memory device further comprising a vehicle inventory manager program that receives a vehicle identifier associated with the vehicle, receives one of the location identifiers corresponding to a location where the vehicle is parked, and stores the one location identifier in association with the vehicle identifier; and a first processor that runs the vehicle inventory program; and
a second memory device further comprising a vehicle locator program that receives a request to locate the parked vehicle within the area, the request including at least a portion of the vehicle identifier, and retrieves the one location identifier in response to the request, based on at least the portion of the vehicle identifier; and a second processor that runs the vehicle locator program.

40. A data processing system as set forth in claim 39 wherein the first memory device is incorporated into a portable computer system having a manual input device and the vehicle inventory manager program is operatively configured to receive the vehicle identifier via the manual input device after the vehicle is parked in one of the plurality of zones associated with the one location identifier.

41. A data processing system as set forth in claim 39, further comprising a camera operatively connected to the vehicle inventory manager program, wherein when the vehicle manager program receives a vehicle identifier, the vehicle inventory manager program receives an image of the vehicle identifier on the vehicle via the camera, and obtains the vehicle identifier from the image using a optical character recognition technique.

42. A data processing system as set forth in claim 41, wherein the image of the vehicle identifier on the vehicle is received after the vehicle is parked in the area and the step of receiving one of the location identifiers comprises:
receiving an image of the one location identifier in association with receiving the image on the vehicle; and
obtaining the one location identifier from the image using the optical character recognition technique.

43. A data processing system as set forth in claim 39, further comprising an infrared detector, wherein the vehicle identifier is incorporated in an infrared tag on the vehicle and the vehicle identifier is received by the vehicle inventory manager program using the infrared detector.

44. A data processing system as set forth in claim 39, further comprising an infrared detector, wherein the one location identifier is incorporated in an infrared tag positioned in proximity to one of the plurality of zones associated with the one location identifier and the one location identifier is received by the vehicle inventory manager program using the infrared detector.

45. A data processing system as set forth in claim 39, further comprising a bar code reader, wherein the one location identifier is incorporated in a bar code positioned in proximity to one of the plurality of zones associated with the one location identifier and the one location identifier is received by the vehicle inventory manager program using the bar code reader.

46. A data processing system as set forth in claim 39, further comprising a wireless reader, wherein the vehicle identifier is wirelessly transmitted from the vehicle and the vehicle identifier is received by using a wireless reader after the vehicle enters the area.

47. A data processing system as set forth in claim 39, further comprising a GPS receiver, wherein each of the plurality of location identifiers correspond to one of a plurality of latitudes and one of a plurality of longitudes, and the step of receiving one of the location identifiers comprises:
receiving a current latitude and a current longitude from the GPS receiver when the GPS receiver is positioned in proximity to the parked vehicle; and
determining the one location identifier based on the current latitude and the current longitude.

48. A data processing system as set forth in claim 39, wherein the vehicle identifier is encoded on a ticket presented to a user of the vehicle when the vehicle enters the area, and the step of receiving a request to locate the parked vehicle comprises reading the encoded vehicle identifier from the ticket.

49. A data processing system as set forth in claim 39, wherein the vehicle identifier is one of a plurality of inventoried vehicle identifiers stored in association with a respective one of the location identifiers, the vehicle inventory manager program is operatively configured to identify an approximate date when the vehicle entered the area and store the identified date in association with the vehicle identifier, and the vehicle locator program is operatively configured to determine whether the portion of the vehicle identifier matches more than one of the inventoried vehicle identifiers in response to receiving the request, and when the portion of the vehicle identifier is determined to match more than one of the inventoried vehicle identifiers, display the vehicle identifier with the identified date stored in association with the vehicle identifier.

50. A data processing system as set forth in claim 39, wherein the vehicle identifier is one of a plurality of inventoried vehicle identifiers stored in association with a respective one of the location identifiers, the vehicle inventory manage program is operatively configured to identify an image of the vehicle and store the identified image in association with the vehicle identifier, and the vehicle locator program is operatively configured to determine whether the portion of the vehicle identifier matches more than one of the inventoried vehicle identifiers in response to the request, and when the portion of the vehicle identifier is determined to match more than one of the inventoried vehicle identifiers, display the vehicle identifier with the identified image stored in association with the vehicle identifier.

51. A data processing system as set forth in claim 39, wherein the vehicle identifier is one of a plurality of inventoried vehicle identifiers stored in association with a respective one of the location identifiers, the vehicle locator program is operatively configured to determine whether the portion of the vehicle identifier matches more than one of the inventoried vehicle identifiers in response to the request, and when the portion of the vehicle identifier is determined to match more than one of the inventoried vehicle identifiers, displaying each of the matching inventoried vehicle identifiers.

52. A data processing system as set forth in claim 51, wherein the vehicle locator program is operatively configured to receive a selection of one of the displayed matching inventoried vehicle identifiers, and in response to the selection, display the location identifier associated with the selected one of the displayed matching inventoried vehicle identifiers.

53. A data processing system as set forth in claim 52, wherein the step of displaying the location identifier comprises displaying a graphical representation of the location identifier relative to a map of the area.

54. A data processing system as set forth in claim 39, wherein the vehicle locator program is operatively configured to display a graphical representation of the retrieved location identifier relative to a map of the area.

55. A data processing system as set forth in claim 39, wherein vehicle locator program is operatively connected to a department of motor vehicles database and the step of receiving a vehicle identifier associated with the vehicle comprises:
receiving a name of an owner of the vehicle; and
identifying the vehicle identifier in the department of motor vehicles database using the name of the owner.

56. A data processing system as set forth in claim 39, wherein vehicle locator program is operatively connected to a stolen vehicles database maintained by a law enforcement agency, the stolen vehicles database having a plurality of stolen vehicle identifiers, and the vehicle locator program is operatively configured to determine whether the vehicle identifier matches one of the stolen vehicle identifiers in the stolen vehicle database, and when it is determined that the vehicle identifier matches one of the stolen vehicle identifiers, notify the law enforcement agency that the vehicle is parked in the area at the one location identifier.

57. A data processing system as set forth in claim 39, wherein vehicle locator program is operatively connected to a warrant database maintained by a law enforcement agency, the warrant database having a second plurality of vehicle identifiers, and the vehicle locator program is operatively configured to determine whether the vehicle identifier matches one of the second plurality of vehicle identifiers in the warrant database, and when it is determined that the vehicle identifier matches one of the second plurality of vehicle identifiers in the warrant database, notify the law enforcement agency that the vehicle is parked in the area at the one location identifier.

58. A data processing system for locating a vehicle parked within an area, the area having a plurality of zones, each zone being associated with a respective one of a plurality of location identifiers, the data processing system comprising:
means for receiving a vehicle identifier associated with the vehicle;
means for receiving one of the location identifiers corresponding to a location where the vehicle is parked;
means for storing the one location identifier in association with the vehicle identifier;
means for receiving a request to locate the parked vehicle within the area, the request including at least a portion of the vehicle identifier; and
means for retrieving the one location identifier in response to the request, based on at least the portion of the vehicle identifier.
